(19) United States
(12) Patent Application Publication
(10) Pub. No.: US 2006/0130147 A1
(43) Pub. Date: Jun. 15, 2006

(54) Method and system for detecting and stopping illegitimate communication attempts on the internet

(76) Inventor: Matthew Von-Maszewski, Westborough, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/300,058

(22) Filed: Dec. 14, 2005

Related U.S. Application Data
(60) Provisional application No. 60/636,179, filed on Dec. 15, 2004.
(60) Provisional application No. 60/659,488, filed on Mar. 8, 2005.

(51) Int. Cl. G06F 15/16; G06F 11/00; G06F 17/00; G06F 11/22; G06F 9/00; G06F 11/30; G06F 11/32; G06F 11/34; G06F 11/36; G06F 12/14; G06F 12/16; G06F 15/18

(52) U.S. Cl. 726/25; 726/13

(57) ABSTRACT

The method and system of identifying and stopping illegitimate communication attempts on the internet includes collecting statistics of a sending IP address from a plurality of subscribers and storing said statistics in a central database. A risk assessment factor is calculated from the statistics to determine the risk that the sending IP address is controlled by an abusive message sender. Afterwards, the risk assessment factor is distributed to the plurality of subscribers so that each of the subscribers may determine whether to accept a connection request from a particular sending IP address according to its own locally set policy.

### CROSS-REFERENCE TO RELATED APPLICATIONS

This application claims priority to earlier filed U.S. Provisional Application Ser. No. 60/636,179 filed Dec. 15, 2004 and U.S. Provisional Application Ser. No. 60/659,488 filed Mar. 8, 2005, the entire contents of which are incorporated herein by reference.

### BACKGROUND OF THE INVENTION

1. Field of the Invention

The present invention generally relates to the transmission of data over the Internet. More specifically, the invention relates to the identification and blocking of distrusted senders of such data over the Internet.

2. Background of the Related Art

The Internet is used for the communication between users via a vast computer network. Such communication can be carried out in many different forms, such as e-mail, web page access via HTML and instant messaging. Other forms include telnet, FTP, SSH and VPN to name a few more. For each communication, there is a sender and a recipient of the data that is transmitted over the Internet. In the example of an e-mail message, a sender prepares and sends a properly formatted message, such as using SMTP protocol, to a recipient on the Internet. The domain name and user name is identified as the recipient and the message is routed to the appropriate e-mail server using the usual DNS (domain name server). The message is then available for access by the user, such as POP (post office protocol) access to the e-mail server.

Other forms of communication via the Internet are similar in that they each have a sender and a recipient where the sender is identified with an IP (Internet protocol) address. An IP address is a unique identifier for a computer or device on a network. Networks using the network protocol route messages based on the IP address of the destination. The present invention supports any type or version of IP addressing. A current typical format of an IP address is a 32-bit numeric address written as four numbers separated by periods. Each number can be zero to 255. The present invention supports future versions of IP, such as IP Version 6 (IPv6) where the address is 128 bits long with a different format.

Unfortunately, it has been commonplace on the Internet for a rogue sender to use both a non-existent (fake) receiver and sender names within an IP message, such as e-mail, in an attempt to make their identity anonymous. This is done primarily for the proliferation of spam and other malicious Internet traffic, such as denial of service attacks.

In the prior art, there have been attempts to identify and then address messages that have been tagged as being false or misleading toward defeating spam and denial of services attacks, for example. As to spam, the content of the message is frequently analyzed to determine whether it meets certain filtering tests. However, this method is not particularly accurate.

Moreover, these rogue senders continue to exist primarily due to three factors: the volume of messages sent by rogue senders, anonymity of the rogue senders, and apathy on the part of receivers individually. Because it only takes one successful connection per million to make the activity worthwhile, rogue senders need to be able to send out thousands of connection requests per minute.

Therefore, there is a need for a method for identifying Internet computer senders based on the trustworthiness of the sender and its IP address rather than on the content of the message itself.

### SUMMARY OF THE INVENTION

The present invention solves the problems of the prior art by providing a method and system of identifying and stopping illegitimate communication attempts on the internet. In particular, the method and system of the present invention includes collecting statistics of a sending IP address from a plurality of subscribers and storing the statistics in a central database. A risk assessment factor is calculated from the statistics to determine the risk that the sending IP address is controlled by an abusive message sender. Afterwards, the risk assessment factor is distributed to the plurality of subscribers so that each of the subscribers may determine whether to accept a connection request from a particular sending IP address according to its own locally set policy.

Accordingly, among the objects of the present invention is the provision for a large scale, distributed detection grid for monitoring each sending IP address.

Another object of the present invention is the provision for a system and method that creates a central database that catalogs statistical behavior of each sending IP Address as perceived by each receiving IP Address within the detection grid. The database catalogs both good and bad behavior statistics, as well as establishes volume estimations due to the statistics.

Yet, another object of the present invention is the provision for a system and method that collects statistics and distributes risk assessments on five minute intervals using existing 3rd party distribution channels. This allows the operation to scale data delivery by orders of magnitude within hours of the need being presented.

Another object of the present invention is the provision for a system and method that enables quick distribution of protective blocking against fraudulent Internet sites based upon requests from law enforcement agencies and other notable entities such as credit card companies.

Yet, another object of the present invention is the provision for a system and method that collects evidence necessary for reporting abuse to IP Address owners automatically. Evidence typically represents a corroborated view of a rogue computer's actions, without risk of accidental leakage or theft of confidential information from the receiving computer. The corroborated evidence is suitable for reporting to federal authorities when warranted.

Another object of the present invention is the provision for a system and method that tracks evidence reports sent to the IP Address owners and the owners' subsequent actions. This tracking information is used as part of an assessment as to the risk of all IP Addresses within the given owner's control. Such tracking and assessment can lead to economic incentive for IP Address owners to act rapidly against rogue behaviors.

Another object of the present invention is the provision for a system and method that enables end-users to participate in identifying rogue messages that leaked through the main blocking server. End-user information travels back to the central database for consideration in future risk assessments and evidence reports.

Yet, another object of the present invention is the provision for a system and method that extends defensive blocking data to both computer and network routers.

Yet, another object of the present invention is the provision for a system and method that exists as a software tool that integrates with existing operating systems and routers.

Another object of the present invention is the provision for a system and method that leaves all IP connections and messages within the customer's infrastructure, allowing for general security and public key encryption.

Another object of the present invention is the provision for a system and method that uses message delay (also known as temporary failure in email processing) with some TCP services, lengthening delivery time of the message to allow group assessment of IP Address prior to initial message receipt.

Another object of the present invention is the provision for a system and method that uses message delay in email processing as a filter of virus and spam messages (limits acceptance of message to “store and forward” email software which is not commonly used by virus and spam software).

Another object of the present invention is the provision for a system and method that applies genetic algorithms to find appropriate heuristic prediction of IP Address range risk based upon address characteristics such as message rate, home country, software running and subscriber experience. This is appropriate to new or low volume IP Address ranges.

Another object of the present invention is the provision for a system and method that utilizes statistical forecasting, after modal transformation, to establish trigger points for bad behavior on high volume sites.

Yet, another object of the present invention is the provision for a system and method that establishes method for quickly notifying owners of high volume IP Addresses when one or more of its supported machines goes rogue, without necessarily blocking the IP Address and causing secondary headaches.

Another object of the present invention is the provision for a system and method that embraces statistical information from other software sources on each computer to support decision process.

Another object of the present invention is the provision for a system and method that establishes active blocking of rogue computer connection attempts on the subscriber computer based upon local database and simple local processing of statistical information with or without active communication to central database. This local decision process enables quick response to local threats/outbreaks within delay period of statistics traveling to central database and back.

Another object of the present invention is the provision for a system and method that allows extension of IP Addresses to telecom telephone numbers for subsequent abuse management of direct marketing phone calls and spam faxes.

### BRIEF DESCRIPTION OF THE DRAWINGS

These and other features, aspects, and advantages of the present invention will become better understood with reference to the following description, appended claims, and accompanying drawings where:

FIG. 1 is an illustration of the preferred embodiment of the system of the present invention;

FIG. 2 is a flowchart of the method of communicating to subscribers of the present invention;

FIG. 3 is a flowchart illustrating the method used to incorporate system data from other processes known running on the clients;

FIG. 4 is a flowchart of the method used to block rogue senders of the present invention;

FIG. 5 is a flowchart of the method used to update the central database of the present invention;

FIGS. 6A-C, when viewed as a whole, are a flowchart of the method of deep review of a sending IP address of the present invention.

### DESCRIPTION OF THE PREFERRED EMBODIMENT

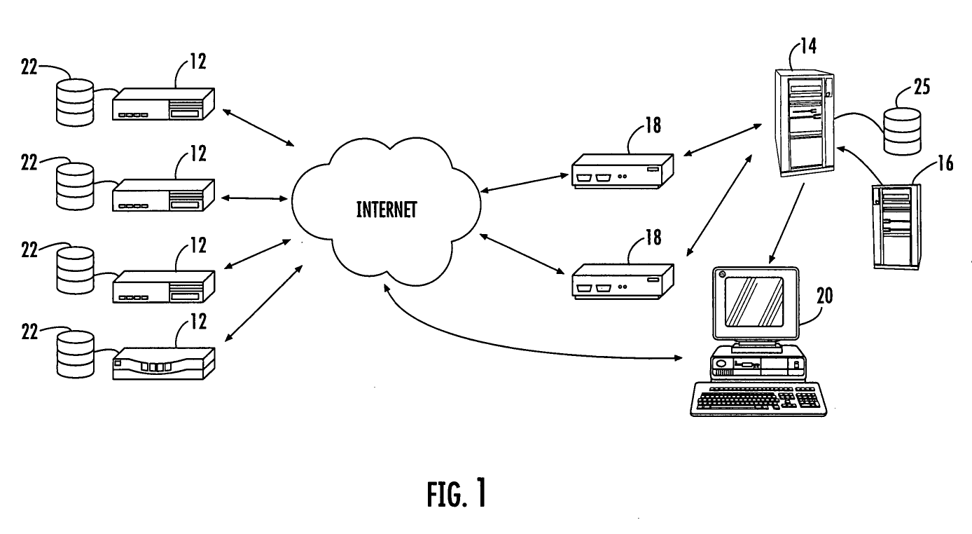

Referring now to FIG. 1, an illustration of the preferred embodiment of the method and system of the present invention is shown generally at 10. In particular, the system of the present invention includes several basic components: a subscriber component 12, a tracking component 14, a forecasting component 16, a delivery component 18, and a portal component 20 all networked together via the internet.

The subscriber component 12 functions on a client owned service or machine and is the “guardian” and “forward scout” of the system of the present invention. The subscriber component 12 could be placed on a number of different services, such as an email server, a router, an HTTP web server, or even an HTTP email server, to name a few. To function properly, the system and method of the present invention must have enough subscriber components 12 operating on a variety of platforms to form a large scale detection grid.

The subscriber component 12 has a local database 22 to track connection requests for a sending IP address the attribute data of the connection request. The subscriber component 12 also collects evidence pertaining to suspicious sending IP addresses and has a repository of local policies and rules for making decisions to block sending IP addresses if the tracking server and/or delivery servers become inaccessible. The local database 22 stores sending IP addresses, triples (described further below), evidence associated with suspicious activity from particular IP addresses and a risk assessment factor for each IP address.

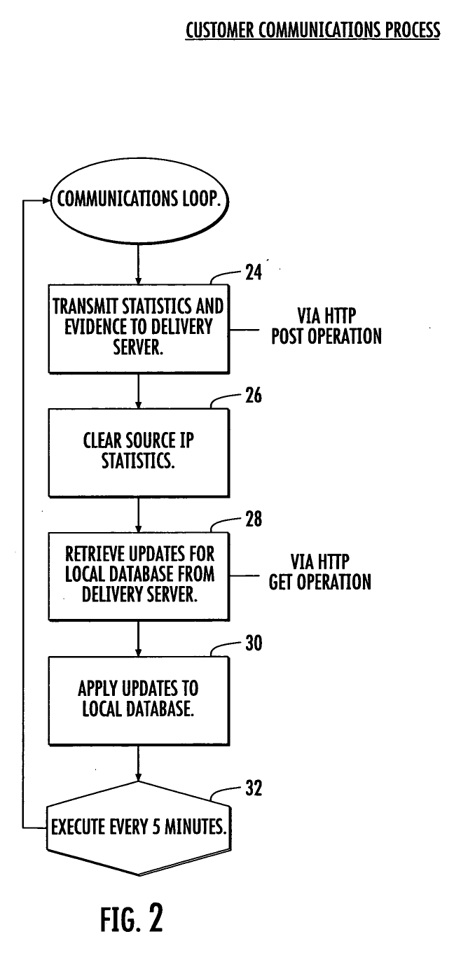

As shown in FIG. 2, the subscriber component 12 continuously updates the local database 22 in a repeating loop. As will be described in greater detail below, the subscriber component 12 transmits 24 to the delivery server statistics compiled from the connection requests it receives from various sending IP addresses. Preferably, this step is accomplished via an HTTP Post operation to a central database 25. Nearly simultaneously, the subscriber component 12 will reset or clear 26 the sending IP address statistics just transmitted to the delivery component 18. The subscriber component 12 will then retrieve 28 updates for the local database 22 from the delivery component 18 preferably via an HTTP Get operation. After retrieving the updates, the subscriber component will apply 30 the updates to the local database 22. Preferably, this loop will repeat every five minutes 32, although other intervals could be easily set as desired.

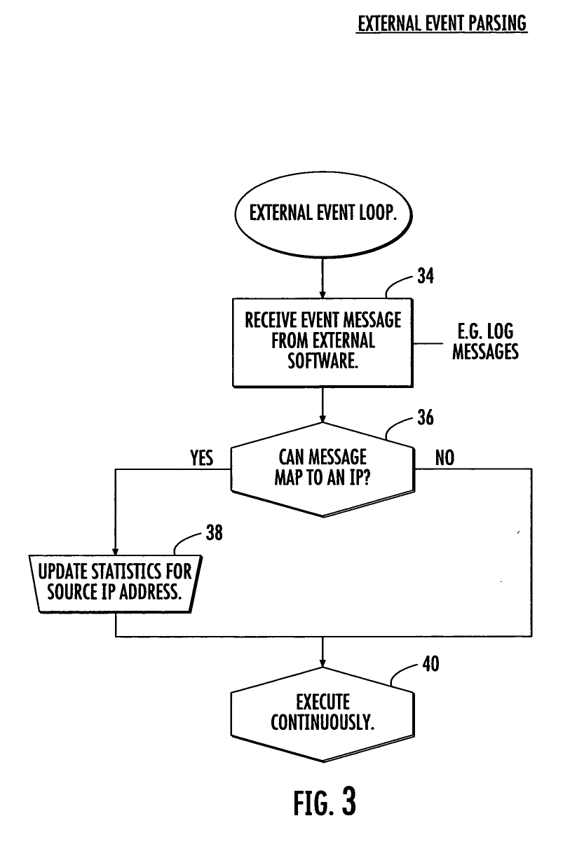

Besides populating the local database 22 from a central database 25 and receiving connection requests (described further below), the subscriber component 12 has the ability to cooperate with other services running on the client machine or service. In particular, any service that maintains a log can be scanned for foreign activity. As shown in FIG. 3, the subscriber component checks 34 for event messages received from external software services. If this event message can be mapped 36 to a sending IP address in the local database 22, the subscriber component 12 will update 38 the statistics for that sending IP address and continue to search for other event messages that can be mapped. This process executes 40 continuously and allows the method of the present invention to inventory other behavior for a sending IP address that might otherwise go undetected. This additional data can be analyzed to help make a more accurate risk assessment for a particular sending IP address.

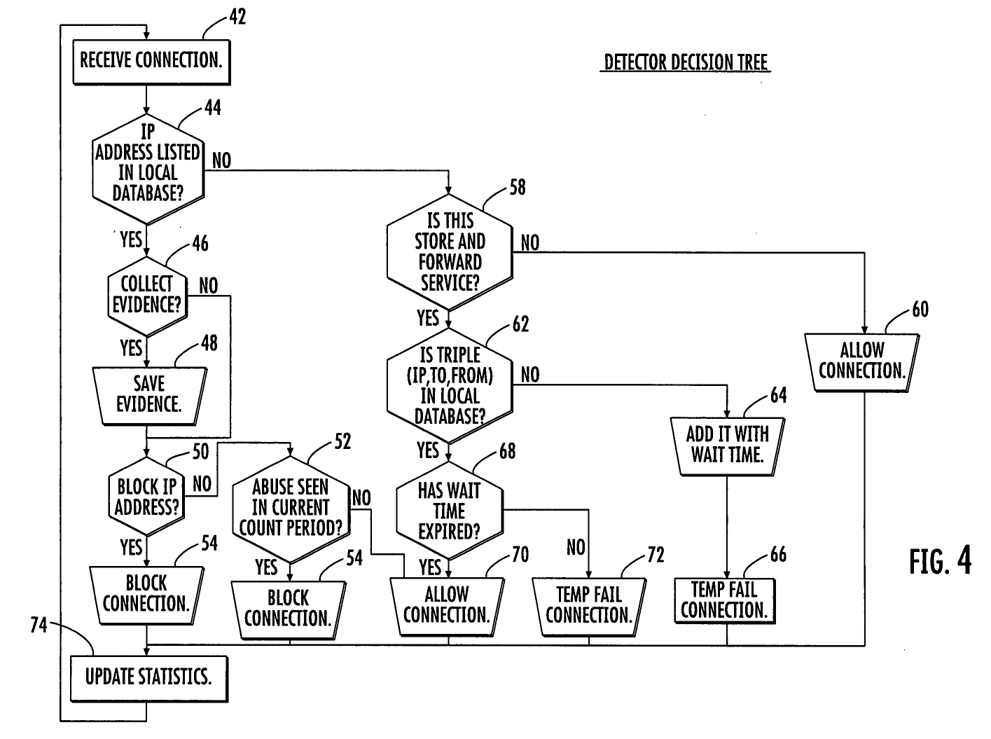

Referring to FIG. 4, the detection algorithm of the subscriber component 12 is illustrated in a flowchart. The subscriber component 12 receives 42 a connection request from a sender. However, prior to allowing the connection, the subscriber component checks 44 the sending IP address against the local database. If the sending IP address has an entry within the local database, meaning that the sending IP address has been flagged as potentially rogue, the subscriber component must decide whether to collect 46 and save 48 evidence and block 50 the connection request or to allow the connection 56. The decision about whether to collect 46 and save 48 evidence is based on whether significant anomalies exist in the connection request itself, for example inconsistencies in the attributes of the sending IP address or attribute data of the connection request, and whether the sending IP address is exceeding specified thresholds 52. In particular, if the sending IP address is exceeding 52 an expected volume or count within a specified time period, the subscriber component 12 will block 54 the connection request. The decision to block 54 the connection is based on the risk assessment factor and the client's risk aversion.

If the sending IP address is not stored in the local database 22 the subscriber component 12 will check the type of request 58. If the request is not a store-and-forward request, the subscriber component 12 will allow the connection 60. However, if the connection request is a store-and-forward request, the subscriber component 12 will check 62 to see if a triple of the connection request has been previously stored in the local database 22. If a triple does not exist, the subscriber component 12 will add 64 a new triple to the local database 22 and set a wait time for a response. The subscriber component 12 will then issue 66 a temporary failed connection message to the sending IP address. If a triple exists in the local database 22 and the wait time has expired 68, the subscriber component 12 will allow the connection 70. If the subscriber component 12 receives a response from the sender and the wait time has not expired 68, the subscriber component 12 will issue 72 another temporary failed connection message.

Ordinarily, when a legitimate sender receives a temporary failed connection request, it will attempt to resend the connection request. Because rogue senders are not usually listening to incoming requests, they usually fail to respond to a temporary failed connection request. The method of the present invention exploits this behavior to block connections from such rogue senders.

After the subscriber component 12 determines what action or actions it will take with a particular connection request, it will update 74 its statistics in its local database 22 and post 24 them to the delivery component 18 for inclusion in the central database 25. The delivery component 18 acts as the gateway between the subscriber components 12 and the central database 25 of the tracking component 14. The system 10 of the present invention envisions multiple delivery components 18 in order to handle the volume of data being transmitted to and from the central database 25 of the tracking component 14.

The tracking component 14 and forecasting component 16 jointly form the heart of the present invention. As alluded to earlier, the tracking component 14 has a central database 25 that aggregates statistics from the subscriber components 12 and preferably stores them indexed by sending IP address. The forecasting component 16 uses the collected statistics stored in the central database 25 to calculate a risk assessment factor for each particular sending IP address. The forecasting component 16 uses a number of statistical forecasting methods to determine the risk assessment factor including a proprietary genetic algorithm to predict whether the sending IP address is that of a rogue sender. The tracking and forecasting components 14, 16 preferably reside together on a single server, although this is not necessary and multiple servers could be used. Moreover, multiple tracking components 14 with multiple central databases 25 could also be used where traffic volume is exceedingly heavy. In this configuration the multiple tracking servers 14 would collectively share its central database 25 with the other tracking components 14.

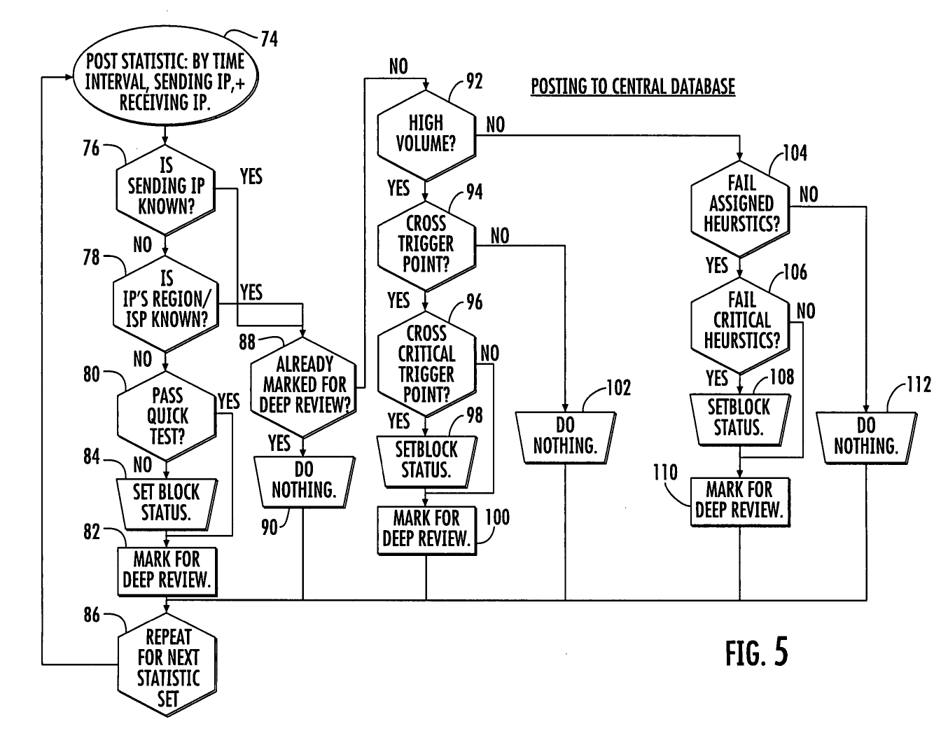

Upon receiving 24 a post from one of the delivery components 18, the tracking component 14, as shown in FIG. 5, will post 74 the statistics to the central database 25 according to the time interval, the sending IP address, and receiver or destination IP address. As part of this process, the tracking component 14 will first verify 76 whether the sending IP address already has an entry in the central database 25 and verify 78 whether the sending IP address's region is known. If the sending IP address or its region 76, 78 does not already have an entry in the central database 25, the tracking component 14 will perform 80 a quick test to check whether at first blush the sending IP address appears to be valid. If the sending IP address passes the quick test 80, the tracking component 14 will mark 82 the sending IP address for deep review and proceed to process 86 the next incoming post. However, if the sending IP address does not pass the quick test 80, the tracking component will immediately set the risk assessment factor 84 to block connection requests.

If the sending IP address does have an entry in the central database 25, the tracking component 14 will check to see if the sending IP address has already been marked 88 for deep review, do nothing further 90, and proceed to process the next post 86. If the sending IP address has not been marked for deep review 88, the tracking component 14 will check to see if the sending IP address is sending high volumes of connection requests 92 by comparing the volume counts collected from the statistics previously collected 24 from the subscriber components 12. If the volume exceeds certain trigger points 94 or critical trigger points 96, the sending IP address will be set for blocking 98 and marked for deep review 100. If the volume counts do not cross the first trigger point, the tracking component 14 will do nothing 102 and proceed to process the next post 86.

If the sending IP address is a low volume sender, the tracking components 14 will run a first set of heuristics 104 against the statistics of the sending IP address to attempt to predict whether the sending IP address might potentially be rogue. If the sending IP address fails the first set of heuristics 104, a second set of heuristics 106 will be run against the statistics of the sending IP address. If the sending IP address fails the second set of heuristics 106, the tracking component 14 will set 108 the risk assessment factor to block the sending IP address and mark the sending IP address for deep review 110. However, if the sending IP address passes the second set of heuristics 108, the tracking component will only mark the sending IP address for deep review 110. If the sending IP address passes both sets of heuristics 106, 108, it is unlikely at this point that the sending IP address is rogue and therefore the resources will not be committed for a deep review of the sending IP address. The tracking component will then do nothing further 112 and proceed to process the next post 86.

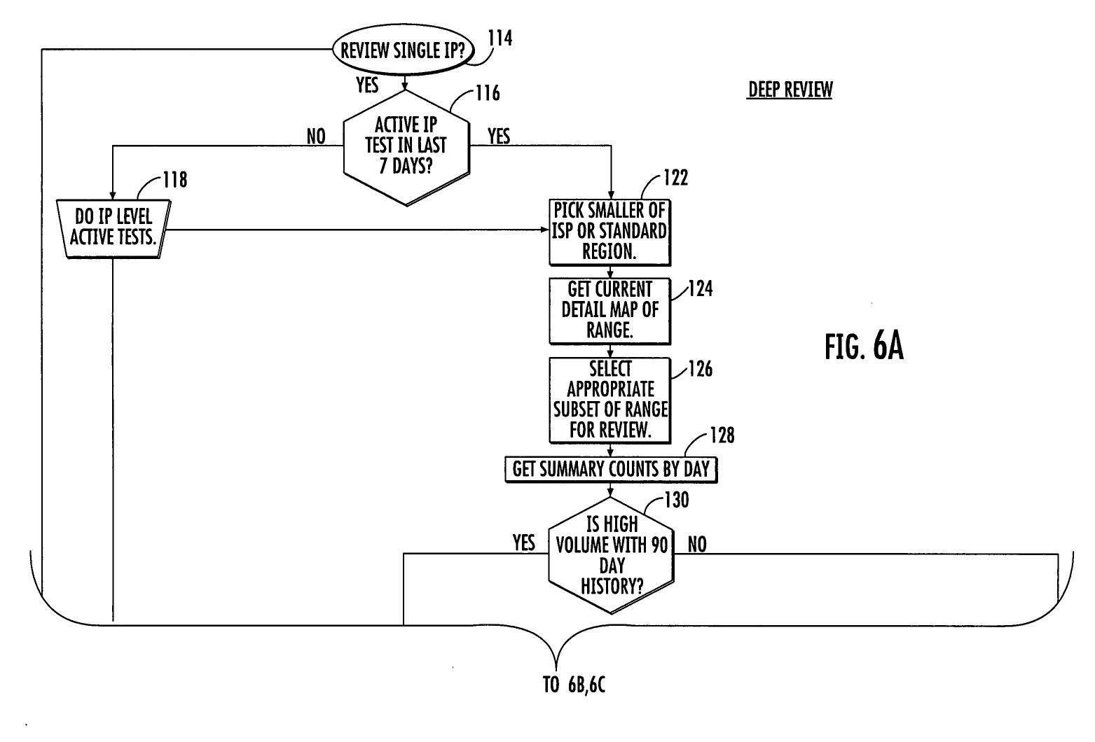

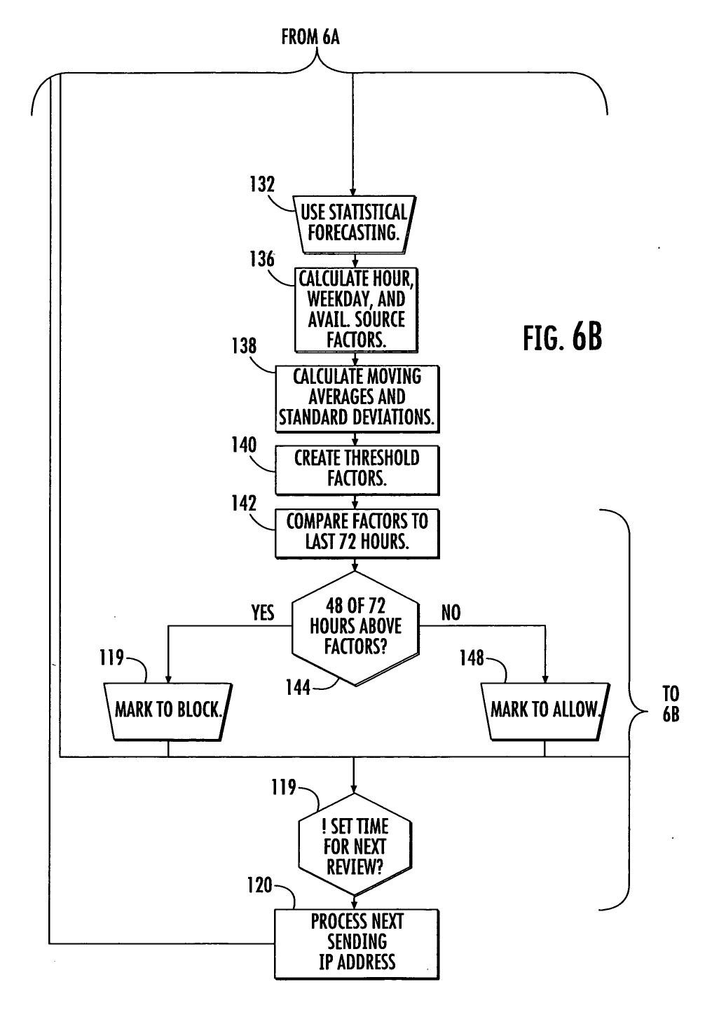

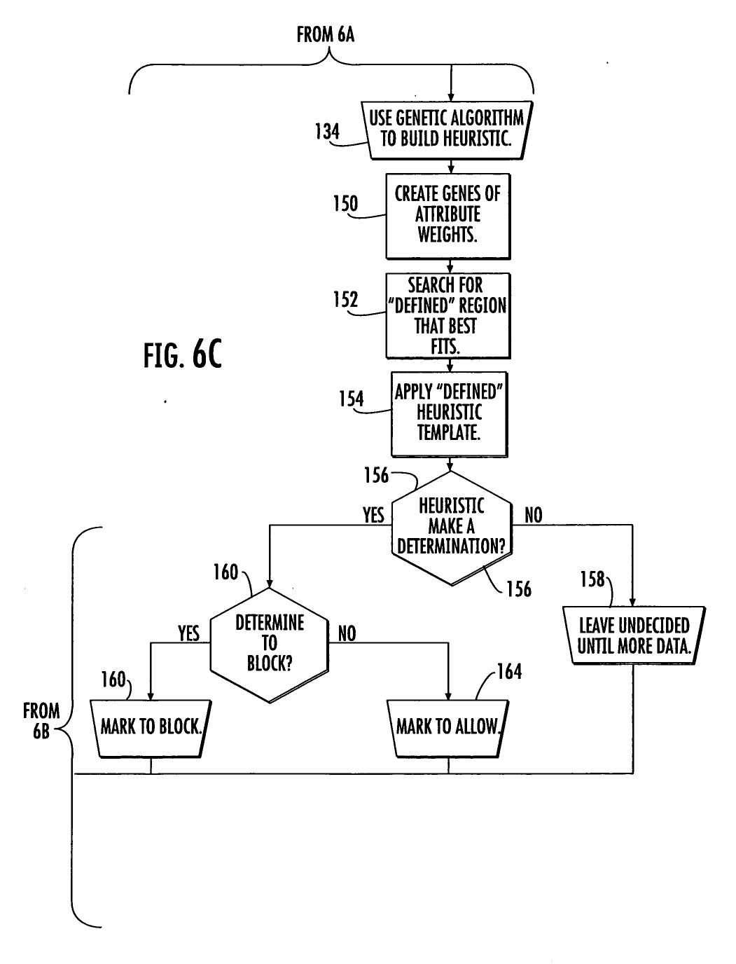

The forecasting component 16 will perform 114 a deep review of the sending IP addresses that the tracking component 14 has marked for a deep review and other sending IP addresses that have not been reviewed for a while as desired. As shown in FIG. 6A, if the sending IP address has not been active in the past week 106, the forecasting component 16 will perform IP level active tests 108 to determine if the sending IP address is still active. If the IP level active tests 108 fail, the forecasting component 16 will then set a time to revisit and deep review the sending IP address 119 and then proceed to process the next sending IP address marked for deep review 120 as shown in FIG. 6B.

Referring back to FIG. 6A, if the IP level active tests 118 pass or the sending IP address has been active within the last week 116, the forecasting component 16 will select the smaller of the ISP or standard region of the sending IP address 122 and create a map 124 of the activity within that selected region. A subset of the map or range will be selected for review 126 and a summary of counts by day will be created 128. If the count volume is high for the last ninety days 130, the forecasting component 16 will use statistical forecasting 132 to attempt to determine whether the sending IP address is an abusive message sender (FIG. 6B). If the count volume is too low 130 for the statistical forecasting methods to be effective, the forecasting component 16 will use a genetic algorithm 134 to predict the future behavior of the sending IP address to create a heuristic template in which the risk assessment factor for the sending IP address can be reasonably predicted (FIG. 6C).

The statistical forecasting methods 132 calculate a number of factors based on the hour, weekday, and reporting subscriber components 12 of the sending IP address 136. From these factors, standard deviations and moving averages can be determined 138, for which threshold factors for the entire period 140 can be created and compared 142 to the preceding 72 hours. If more than two-thirds (i.e. 48) of calculated factors exceed the threshold factors 144, the sending IP address will assign 146 a risk assessment factor to block connection requests from the sending IP address. Otherwise the sending IP address will assign 148 a risk assessment factor to allow connection requests from the sending IP address. The forecasting component 16 will then set a time 119 for when the sending IP address should be reviewed again and proceed to process the next sending IP address marked for deep review 120.

As mentioned previously, if the volume within the last ninety days is too low 130 to be effective, the forecasting component 16 will use a genetic algorithm 134 to build a heuristic template to predict whether the sending IP address is an abusive message sender. The genetic algorithm 134 uses the collected statistics, which include the attribute data of the connection requests, to seed 150 the “genes” of the genetic algorithm. The genetic algorithm is then run and the results are searched for a defined region 152 that best characterizes the potential future behavior of the sending IP address. From this defined region 152, a heuristic template is constructed 154 and the heuristic template is tested 156 to see whether it can make prediction. If the defined region is too indistinct, non-existent, or the heuristic template otherwise proves unusable, the forecasting component 16 will leave the risk assessment of the sending IP address undecided until further data can be collected 158. If the heuristic template proves useful, the sending IP address will be tested 160 against it and the risk assessment factor set to block 162 or allow 164 connection requests accordingly. The forecasting component 16 will then set a time to revisit the sending IP address for another deep review 119 and proceed to process the next sending IP address 120.

Although, the above-method has been described as setting the risk assessment to either block connection requests or allow connection requests from a particular sending IP address, the risk assessment factor is in fact a bit more refined. Preferably, the risk assessment factor includes four levels. The default risk assessment for any IP address is to monitor the IP address. Any decision to accept or block a connection request is left entirely to the subscriber component 12 and any other measures the client has put in place to deter abusive message senders. Marking a sending IP address as allowed, allows all communication with the sending IP address.

Marking a sending IP address for blocking includes two levels—a graceful block and a chronic block. Under a graceful block, the sending source is sent a message as to why the connection request was denied and contact information to resolve the block. Some protocols, such as SMTP and HTTP support this feature. However, some simpler protocols, such as FTP, do not support this feature and are only capable of refusing the connection with no explanation. The graceful block is the default blocking level assigned for sending IP addresses that have been marked for blocking. A chronic block blocks a connection request outright and leaves the connection request unanswered, thereby making the receiver of the connection request appear as a “black hole” to the sending IP address. Although, a four level system for assigning risk assessment factors is preferred, other levels could be included depending on the scope of blocking that is desired.

Referring back to FIG. 1, the protocol component 20 preferably resides on a separate server, although it could be included on the same server as the tracking component 14 or the forecasting component 16. The protocol component's 20 main function is to report abuse to the registered owner of the sending IP address and to any law enforcement or regulatory authorities as deemed appropriate. The protocol component 20 prepares a report of the abuse using the collected evidence stored on the central database 25 that was compiled earlier by the subscriber components 12.

Therefore, it can be seen that the present invention provides a unique solution to the problem of detecting and throttling abusive message senders on the internet by providing a system and method that analyzes a sending IP address with respect to the collective experience of the internet community with the sending IP address.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method of identifying and stopping illegitimate communication attempts on the internet, comprising the steps of:
collecting statistics of a sending IP address from a plurality of subscribers and storing said statistics in a central database;
calculating a risk assessment factor from said statistics of the risk that the sending IP address is controlled by an abusive message sender; and
distributing said risk assessment factor to the plurality of subscribers so that each of said plurality of subscribers may determine whether to accept a connection request from said sending IP address according to a locally set policy at each of said plurality of subscribers.

2. The method of claim 1, wherein said risk assessment factor is distributed every five minutes.

3. The method of claim 1, wherein the step of calculating a risk assessment factor includes using a genetic algorithm to predict the risk assessment factor.

4. The method of claim 1, wherein the step of calculating a risk assessment factor includes using a statistical method based on the volume of connections requests received over a predetermined period of time to predict the risk assessment factor.

5. The method of claim 1, further comprising the steps of:
collecting evidence that sending IP address of the sending source is rogue; and
forwarding said evidence to a registered owner of the sending IP address.

6. The method of claim 5, further comprising the step of forwarding said evidence to law enforcement and regulatory authorities.

7. A method of identifying and stopping illegitimate communication attempts on the internet, comprising the steps of:
receiving a connection request from a sending source having an IP address;
compiling statistics of the sending characteristics of the IP address of the sending source;
storing said statistics in a local database;
posting said statistics to a central database having a plurality of statisitics compiled from a plurality of subscribers about the IP address of the sending source;
calculating a risk assessment factor from said plurality of statistics;
updating the local database with the risk assessment factor; and
determining whether to allow the connection request by comparing the risk assessment factor of the IP address of the sending source against a locally set policy on acceptable risk.

8. The method of claim 7, further comprising the step of issuing a temporary connection failure to the IP address of the sending source.

9. The method of claim 7, further comprising the step of leaving the connection request unanswered.

10. The method of claim 7, wherein said step of compiling statistics of the sending characteristics of the IP address of the sending source, comprises the step of recording the interval at which the sending source sends internet services messages.

11. The method of claim 7, wherein said step of compiling statistics of the sending characteristics of the IP address of the sending source, comprises the step of recording the volume of requests received from the IP address of the sending source.

12. The method of claim 7, wherein said step of storing statistics in a local database comprises the step of recording a triple consisting of the IP address of the sending source, the sender identification, and receiver identification of the connection request.

13. The method of claim 7, further comprising the steps of:
collecting evidence of the sending source; and
posting said evidence to the central database.

14. The method of claim 13, further comprising the step of sending said evidence to the registered owner of the IP address.

15. The method of claim 13, further comprising the step of sending said evidence to law enforcement and regulatory authorities.

16. The method of claim 7, wherein the step of collecting evidence of the sending source comprises the step of recording the message header of the connection request.

17. The method of claim 7, wherein said connection request is selected from the group consisting of: SMTP, FTP, SSH, HTTP, Telnet, and VPN.

18. The method of claim 7, wherein said connection request is store-and-forward request.

19. A system for detecting and throttling rogue senders on the internet having a plurality of subscriber components, comprising:
a tracking component having a database for storing statistics of connection requests for a plurality of sending IP addresses,
a forecasting component for analyzing said statistics of the plurality of sending IP addresses and calculating risk assessment factor for each of the plurality of sending IP addresses;
one or more delivery components for storing statistics of the plurality of sending IP addresses from the plurality of subscriber components and transmitting the risk assessment factor to the plurality of subscriber components.

20. The system of claim 19, wherein the forecasting component uses a genetic algorithm to calculate the risk assessment factor for each of the plurality of sending IP addresses.

21. The system of claim 19, wherein the forecasting component uses a statistical algorithm based on the volume of connection requests over a predetermined period of time made by each of the plurality of sending IP addresses to calculate the risk assessment factor for each of the plurality of sending IP addresses.

22. The system of claim 19, wherein the one or more delivery components transmit the risk assessment factor to the plurality of subscribers every five minutes.

23. The system of claim 19, wherein the tracking component stores evidence collected from the plurality of subscribers that sending IP address of the sending source is rogue; and
a portal component for preparing and transmitting said evidence to the registered owner of the sending IP address.

24. The system of claim 23, wherein said portal component transmits said evidence to law enforcement and regulatory authorities.
